(19) United States
(12) Patent Application Publication
(10) Pub. No.: US 2006/0258436 A1
(43) Pub. Date: Nov. 16, 2006

(54) MULTIPLE SPIN SLOT MACHINES

(76) Inventor: Scott McBride, North Bay (CA)

Correspondence Address: SCHMEISER, OLSEN & WATTS, 22 CENTURY HILL DRIVE, SUITE 302, LATHAM, NY, 12110, US

(21) Appl. No.: 11/381,754

(22) Filed: May 5, 2006

(30) Foreign Application Priority Data
May 6, 2005 (CA) 2,506,160

(51) Int. Cl. A63F 13/00

(52) U.S. Cl. 463/20

(57) ABSTRACT

A gaming apparatus and method of playing a gaming apparatus wherein, with each spin, the player is afforded the option of effecting a singular spin of the reels so as to randomly generate one number which can be compared with a list of potential outcomes to determine if the player will win or lose, or of effecting multiple spins on a slot machine so as to randomly generate multiple numbers which can all be compared with a list of potential outcomes to determine if the player will win or lose. In this manner, the player utilizing the slot machine can “fast track” the game to jump directly to a greater quantity of favourable “winning” randomly generated numbers, in a shorter period of time, by virtue of the player being able to play multiple spins at one time.

### FIELD OF THE INVENTION

The present invention relates to a gaming apparatus of the type commonly known as slot machines, wherein a plurality of reels are set into rotation by a player effecting a “spin”, each spin activating a random number generator that generates a number which is then compared with a list of potential outcomes to determine if the player will win or lose, and the stopping position, as indicated by indicia on the periphery of the reels, indicates the payoff to the player. More specifically, the present invention relates to a gaming apparatus wherein the player is afforded the option of effecting a singular spin of the reels, or of effecting multiple spins on a slot machine so as to generate multiple randomly generated numbers (one for each spin) which can all be compared with a list of potential outcomes to determine if the player will win or lose. In this manner, the player utilizing the slot machine can “Fast track” the game to jump directly to the favourable “winning” randomly generated numbers associated with each winning spin, by virtue of the player being able to play multiple spins at one time.

### DESCRIPTION OF THE PRIOR ART

Slot machines (“slots”) account for over two-thirds of casino revenue in the United States. These machines have been around since it was invented by Charles Fey in 1895, and although they have evolved since, their popularity still holds true. In most cases, they generate large revenues for a casino. For example, casinos have many more slot machines than casino table games like Blackjack. For instance, Foxwood's Resorts and Casinos, known as the largest casino in the world, at last count has 7,374 slot machines and 311 table games, a ratio of 23 slot machines to one table game. People enjoy slots because unlike other games, the player does not have to possess skill, and you can play at your own pace. There are two types of slot machines, straight slots and progressive slots. The straight slots payout a predetermined amount and the progressive slots have a jackpot that's based on a percentage of each coin played.

Slot machines offer a wide variety of machine types to play. Differing machines may offer variations in the denomination, the number of reels present on each machine, the amount of pay lines and how many coins a person can play at once. Quarter and dollar machines are still quite popular, and depending on the casino, you can find nickel and even penny machines.

Currently, most slot machines work the same way. A player first places an amount of money into the slot machine and the inserted amount is shown to the player in what is called a credit meter. Although machines now have a feature called “Multi Denomination”, where a player may choose to change the amount they are playing for to different denominations, so that they may play either nickels, quarters, or dollars on the same machine, still most slot machines have a set, fixed amount that is required to play the machine. A slot machine may be, for example, a penny slot machine or one that requires up to and over $100 per spin. Players may place money into machines, or newer technology allows for players to use other methods like player cards or just a piece of paper that may have a bar code and let the machine know how much to increment the machines credit meter by. For example, if a player put $20 into a machine that was a quarter machine, the credit meter would be incremented $20 worth of quarters; in $20, there are 80 quarters. In this example, if a slot machine was a quarter machine and the player put in $20, they would have 80 credits.

As noted above, usually slot machines have a set amount which players may bet up to per spin. This may or may not be, but usually is limited. A player at a quarter machine, for example, may have the option to bet up to 5 quarters, or possibly more, per spin. Most common on a quarter machine might be 2 or likely 3 quarters per spin as a maximum the player would be allowed to play. If a player is allowed to play maximum 3 quarters per spin and the player placed $20 into a quarter machine, the player would have enough credits to spin the reels 26 times (26×3=78) at maximum coins or a full 80 spins at just one coin if allowed on that machine. Players are usually not required to bet the same amount on different spins, so may spin one credit one spin, and three the next.

Of course as a player spins the slot machine the player may win on any spin. Slot machines have pay charts, usually listed on the machine, which clarify for the player how he will be paid depending upon the results of his spin. Although every machine is different, many slot machines have what are called Reels. These reels have many different symbols on them as well as a blank space between each symbol. To activate the spin process, players usually press a button on the face of the machine or, as slot machines were originally designed, pull a handle or arm on the side of the machine. This is why slot machines are also known as “one-armed bandits”.

As the reels spin, what the player does not see is the inner workings of a slot machine. On the inside, the computer or computer processor which is associated with the slot machine has a “Random Number Generator” that generates a number to compare to a list of possible outcomes. Sometimes a Random Number is generated for each reel and this is compared to a list of what symbol might come up on that particular reel. Random Number Generators, or the process of Generating a Random Number are well known throughout the industry. Although using Random Number Generators is not the only method used to determine what outcome will be displayed and to determine if the player will win or lose, this is the most common method. Once the computer or computer processor has generated a random number, this number is compared with a list of potential outcomes to determine whether the player will win or lose. These potential outcomes are determined by the manufacturer. This is often called the “platform”. Each slot machine has a platform that figures out how often the player will win, what payouts will occur and what the casino will ultimately make in the long run. This is called the casino hold, or payback, as it is also known. Each slot machine may pay back to the players a different amount of money. This is most often referred to as a percentage. For instance, casinos might promote their machines or a machine as paying back 97% of the time. In doing so, they are saying that if you place $100 into the machine, you are likely to get $97 back as a return.

When the slot machine has internally determined the “Random Number Generated” number, and it is compared to the list of outcomes, it is brought back to the player in an understandable outcome. The actual reels on the slot machine will now stop, usually one at a time from left to right. As each reel stops, and there is no limit to the number of reels across or on a machine, the reel will stop across what is known as a payline. The payline is a line, or many lines, on the face of the slot machine, or video poker machine, where if certain symbols show up across this line, the player may win or lose. This payline is often, but not always, highlighted on the machine, on the glass which often covers the reels on the machine. When the reels have now all stopped the player usually has a visual of if they won or lost on this spin. The evidence is usually on the payline. Winning payouts are usually listed on the machine so the players would know ahead of the spin what they might look for as winning combinations, and the top prize on that machine.

If, after the reels stop, no winning combination is across any of the slot machine's paylines, this would usually mean a losing combination and the machine would now wait for the player's next action.

If the reels were a winning combination, the player's credit meter might be incremented if it was that kind of win. Quite often in the new “game within a game,” the player has a winning combination, or potential winning combination, but the amount they win, if any, is not determined yet. For instance in the popular game “Wheel of Fortune™,” players may get a “Spin the Wheel” symbol on the machine. At this point they may not have actually won anything, but by the spinning of the wheel, they may be guaranteed a prize. The player would now hit some button to activate the wheel or other “game within a game” option, and subsequent win, as per the machine's further action.

If the player does win they will be given a reward, usually money. Although players could win anything, like dinner from the casino, or a new car, they are most likely to win money, which could appear in credits in their credit meter. If the player won more money than the slot machine pays in the credit meter, a representative from the casino may come to the machine and actually pay the payer in the form of money, cheque or other payment method.

Although they keep changing the actual face of the slot machine, from Wheel of Fortune™, to Elvis™, from Jeopardy™ to Monopoly™ and The Price is Right™; true slot machine innovations are moving at a slower pace. One drawback to the slot machine is the speed at which it can be played. In the modern day and age, players love speed and action and are attracted to faster paced games.

A slot machine is limited as to how fast the actual machine can spin the reels, spitting out a winning or losing combination, incrementing a player's win in the credit meter and accepting the next input from the players to spin the reels again. Averaging a spin in 5 seconds time is very fast and continuous. As fast as this may seem, to a slot machine user, this can be at many times ridiculously slow, since, if a player is spinning the machines at the 5 second pace described, they are getting about 12 spins in one minute. If this pace could possibly be maintained for one straight hour, the player could accomplish as many as 720 spins. For our figures, let's say they actually were able to spin 1,000 spins in one hour. This is a whopping spin every 3.6 seconds.

From a casinos point of view, the machines could never spin fast enough. A player's point of view, might very well depend on the player, or the actual time the player is playing.

Imagine, if you would, some of these examples of ordinary things that involve a high number of slot machine users. People often frequent the casino in a group, and so they come and go in this same group. A larger group of players, say 6, may have 2 players who want to keep playing where as the other 4 want to go and eat, go to a show or go home.

Other times slot machine players may be pressed for time because of their shortness of their duration of stay. That could literally be only a few days of play, for a visitor to a destination place like Las Vegas, or down to just hours. When players are limited in time of play, conventional slot machines can seem slow when considering the amount of play a player can get during those limited periods.

In casinos, players often play different games, such as Blackjack, and between the shuffling of the cards, the players like to stand up and stretch. Many players during this time enjoy playing a few spins of a slot machine. Quite often they don't get too many spins before it is time to get back to playing the table game that the dealer is now ready to play again.

Still other times a player just wants to play and get it over with, so to speak. Many players will stop and play progressive slot machines, where there is a million dollar jackpot, or others where you can win a new car or truck. These machines usually only pay out for the big prizes and not a lot of smaller prizes, but the sheer size of the prize is often enticing enough to a player to give it some brief play. Players like to go for it, win or lose, and move on to the other entertainment that casinos offer. In essence then, there are times when the conventional slot machine just is not fast enough for them, and they want more action, more play, in a shorter period of time.

Another issue with conventional slot machines is the makers of the slot machines are not only constantly competing with one another for the next best thing to sell their machines, but they are also trying to add worth to their machines in order to get noticed over their competition. The best way a manufacturer can get his machine noticed is to do one of two things; A) Give the players the machine they want to play over all others or B) give the casino the machine they want above all others. Accomplish both those things, like Triple Play Poker did, and you have a winner.

Casinos on the other hand usually only care about one thing, which is how much money is being made. If the casino makes money, they like the product and if they don't, they don't. It is simple. Casinos add thousands of slot machines this way so they can attract as many players as possible, giving them all the options those players are looking for to be entertained, and in turn, leave their money behind as profit for the casinos. Unfortunately, even a casino with thousands of slot machines is limited in several ways. They can only have their limited slot machines spun a limited number of times by a limited number of people. A Casino like Foxwood's with 7,374 slot machines can only have a set limited amount of spins every several seconds, since these generate one play per spin.

Casinos know they make their money by the machines being played. The more times a machine is spun, the more times the casino is working on their built in house advantage, which translates to profit. So a player spinning a slot machine 1,000 times per hour is making the casino more money than a player who spins it 250 times. For the casino, the more spins the better. Obviously even the biggest casinos in the world are still restricted in the amount of space they have for slot machines. It can be argued that if all casinos had an unlimited amount of space for placing slot machines, they would have more slot machines. Many casinos would like more machines, but simply do not have the physical space. Accordingly, there is need for a slot machine having the option for the player to effect multiple spins on a slot machine at one time, so as to randomly generate multiple random number generators which can all be compared with a list of potential outcomes to determine if the player will win or lose, very quickly. In this manner, the player utilizing the slot machine can “fast track” the game to jump directly to favourable “winning” randomly generated numbers, by virtue of the player being able to play multiple spins at one time or play. In this manner, such a slot machine could be utilized to maximize the number of spins per hour per slot machine for a casino, while at the same time providing players with an exciting player option, which also maximizes a player's time at the slot machine. The present invention substantially overcomes this problem.

### SUMMARY OF THE INVENTION

The object of the present invention is to provide an improved gaming apparatus and method of playing a gaming apparatus wherein, with each spin, the player is afforded the option of effecting a singular spin of the reels so as to generate one randomly generated number for that spin (in essence one final outcome), or the option of effecting multiple spins on a slot machine, so as to generate multiple randomly generated numbers, one for each spin, which can all be compared with a list of potential outcomes to determine if the player will win or lose and by doing so creating many different play outcomes at one time.

It is another object of the present invention to provide an improved gaming apparatus and method of playing a gaming apparatus, wherein a player utilizing the slot machine can “Fast track” the game to jump directly to a greater quantity of favourable “winning” randomly generated numbers, in a shorter period of time, by virtue of the player being able to play multiple spins at one time. This is an obvious advantage when playing slot machines of the low denominational variety, where playing singular spins can be too time-consuming and frustratingly slow. Accordingly, the present invention presents these types of machines, as well as other types, more attractive to a player.

It is a still further object of the present invention to maximize the potential number of times a slot machine can be spun in a specified time period, so as to enable a casino to maximize their built in house advantage, which translates to increased profits. This maximizes the space on the casino floor for slot machines to generate profits, without requiring the casino to add further slot machines to generate more spins (more spins per machine per day).

According to one aspect of the present invention, there is provided a slot machine comprising a singular spin play command, which can be activated by the user to generate a single random number; a multiple spin play command which can optionally be activated by the user for generating multiple random numbers; at least one display reel having a plurality of game symbols thereon, a plurality of display reels with each reel having a plurality of game symbols arranged thereon; display means for displaying the game symbols; reel drive means responsive to the singular spin play command, when the singular spin play command has been selected by the user, for rotatably driving and stopping the at least one display reel; multiple spin reel drive means responsive to the multiple spin play command, when the multiple spin play command has been selected by the user, for rotatably driving and stopping the plurality of display reels; random number generator means for generating the single random number, in response to the activation of the singular spin play command by the user, or generating the multiple random numbers, in response to the activation of the multiple spin play command by the user, from a predetermined set of random numbers; and processing means for comparing the single random number or multiple random numbers to a predetermined set of potential game results so as to establish a game result.

According to another aspect of the present invention, there is provided a slot machine comprising an input sensor for sensing tokens delivered to the slot machine; a processor operatively connected to the input sensor for receiving information about the tokens entered into the slot machine and for initiating a cycle of the slot machine; a singular spin play command, which can be activated by the user to generate a single random number; a multiple spin play command which can optionally be activated by the user for generating multiple random numbers; at least one display reel having a plurality of game symbols thereon, a plurality of display reels with each reel having a plurality of game symbols arranged thereon; display means for displaying the game symbols; reel drive means responsive to the singular spin play command, when the singular spin play command has been selected by the user, for rotatably driving and stopping the at least one display reel; multiple spin reel drive means responsive to the multiple spin play command, when the multiple spin play command has been selected by the user, for rotatably driving and stopping the plurality of display reels; random number generator means for generating the single random number, in response to the activation of the singular spin play command by the user, or generating the multiple random numbers, in response to the activation of the multiple spin play command by the user, from a predetermined set of random numbers; and wherein the processor compares the single random number or multiple random numbers to a predetermined set of potential game results so as to establish a game result.

According to a still further aspect of the present invention, there is provided a slot machine comprising play means which can be activated by the user to generate a single random number for a single spin, or which can optionally be activated by the user to generate multiple random numbers, each of which is associated; a plurality of display reels with each of the reels having a plurality of game symbols arranged thereon; display means for displaying the game symbols; reel drive means responsive to the play means for rotatably driving and stopping the plurality of display reels; random number generator means for generating the single random number or generating the multiple random numbers, in response to the activation of the play means by the user, from a predetermined set of random numbers; and wherein the processor compares the single random number or multiple random numbers to a predetermined set of potential game results so as to establish a game result, the game result being displayed to the user by the display means.

The advantage of the present invention is that it provides an improved gaming apparatus and method of playing a gaming apparatus wherein, with each spin, the player is afforded the option of effecting a singular spin of the reels which generates one randomly generated number, or the option of effecting multiple spins on a slot machine, so as to generate multiple randomly generated numbers which can all be compared with a list of potential outcomes to determine if the player will win or lose.

A still further advantage of the present invention is that it allows an improved gaming apparatus and method of playing a gaming apparatus, wherein a player utilizing the slot machine can “Fast track” the game to jump directly to a greater quantity of favourable “winning” randomly generated numbers, in a shorter period of time, by virtue of the player being able to play multiple spins at one time.

Yet another advantage of the present invention is to maximize the potential number of times a slot machine can be spun, so as to enable a casino to maximize their built in house advantage, which translates to increased profits. This maximizes the space on the casino floor for slot machines to generate profits, without requiring the casino to add further slot machines to generate more spins.

### BRIEF DESCRIPTION OF THE DRAWINGS

A preferred embodiment of the present invention is described below with reference to the accompanying drawings, in which:

FIG. 1 is a plan view of the appearance of the slot machine according to one embodiment of the present invention;

FIG. 2 is a block diagram of one embodiment of the internal mechanism of the embodiment of the slot machine presented in FIG. 1; and

FIG. 3 is a block diagram illustrating the operation of the microcomputer 29 shown in FIG. 2.

### DESCRIPTION OF THE PREFERRED EMBODIMENT

Multi Spin Slots (MSS) is, in essence, a player option for providing a means of effecting multiple spins on a slot machine so as to randomly generate multiple numbers which can all be compared with a list of potential outcomes to determine if the player will win or lose. In this manner, the player utilizing Multi Spin Slots (MSS) on a slot machine can “fast track” the game to jump directly to favourable “winning” randomly generated numbers, by virtue of the player being able to play multiple spins at one time. Multi Spin Slots (MSS) is thus a way to allow a slot machine to be spun at a much quicker rate than normal slot machines, catering to the player, manufacturer and the casino. Although MSS is very broad in what it can encompass, the idea itself is as simple as it is ingenious. MSS could be applied to some form of gaming device similar to either a slot machine or video poker machine. The many different variations of slot machines and video poker machines and other gaming and gambling devices that are found in the entire industry are all devices that MSS could be applicable too, which would be readily apparent to one skilled in the art.

Ideally, MSS is placed on all these different gaming machines. Presently, slot machines (and it is known to one skilled in the art, that each reference to slot machines also encompasses all other games, such as video poker machines or kiosks as well), allow players to play one spin at a time, whereby a player will press a button and spin the reels for one game. They will likely win or lose on this one spin. If they don't win or lose on this one spin, they likely are awarded something else, such as another opportunity to play a bonus round or what is known as “a game within a game”, like spinning the reels at Kneel of Fortune™. MSS, however, is very different. MSS is a player option, such that the player may play the slot machine of the present invention without using use the MSS option. In effect, this player would be using the “default” mode of play, whereby one play=one spin at a time. At the same time, MSS may be used on every spin at the slot machine, if the player so desires, whereby, in essence, one play=multiple spins generated at one time. In a preferred embodiment, the player may select how many multiple spins generated at one time, such as. For example, 2, 5 10, 25, 100 or even more spins.

For example, if a player decides to spin the machine 10 times and elects to play 3 coins on each of those 10 spins, the machine could list these numbers in a visible area, such as on the display window of the slot machine, where the player can easily see them. Of course it is possible to total these for the players to see how many actual credits the player would spend on his next spin. For instance:

| Spins | Credits/Coins Bet | Total Bet |
|---|---|---|
| 10 | 3 | 30 |

This could be found anywhere on the machine, even beside the player's actual credit meter. Of course, the player would not be able to make a bet that exceeds his current total credits in the game. In the above example, if the player had more than 30 credits they could make this bet. It is possible that the first inputs would change the numbers and totals of the others where necessary. We could add the credit meter into this scenario as follows:

| Spins | Credits/Coins Bet | Total Bet | Credits |
|---|---|---|---|
| 10 | 3 | 30 | 60 |

Each time the player adds to the spin, the Total Bet and the Credits would change accordingly, as follows:

| Spins | Credits/Coins Bet | Total Bet | Credits |
|---|---|---|---|
| 11 | 3 | 33 | 57 |

Whereas by adding to the spins the Total Bet is being increased dependant on the coins being bet for each spin. At the same time the credit meter is being deducted in this example. Now if the player changed the coins Bet from 3 to 2 in this example, the following display would occur:

| Spins | Credits/Coins Bet | Total Bet | Credits |
|---|---|---|---|
| 11 | 2 | 22 | 68 |

As we can see the numbers all change depending on what the player elects to do. If, in the above example, the player now decided to reset the machine by, for example, pressing a reset button, or by pressing the default “single spin button instead of utilizing the multi-spin option (as hereinafter described), all the settings go back to default and the credit meter is reflected accordingly. By pressing the reset button the machine could look like this:

| Spins | Credits/Coins Bet | Total Bet | Credits |
|---|---|---|---|
| 0 | 0 | 0 | 90 |

The player may now use the machine just like a normal slot machine, in that is defaulted back to a single spin=a single play. He may then spin one spin at a time for the desired credits he wishes per spin.

Going back to the earlier example, a player may decide he wishes to continue to use the MSS feature found on the slot machine. Using the methods offered to change the spins per spin, and the number of coins they wish to bet on each of those spins, the player may set up something similar to this:

| Spins | Credits/Coins Bet | Total Bet | Credits |
|---|---|---|---|
| 10 | 3 | 30 | 60 |

So in this example above, the player has 90 credits. They have changed the number of spins to 10 spins and then the coins bet per spin to 3 in this example and the Total Bet is reflected (10×3=30). The Total Bet is deducted from the actual credit meter and is shown as 60.

In a preferred embodiment, it is important to understand that, as the player sets up the machine, if he is playing the multiple spin feature, he has not actually committed himself to any decision that as of yet cannot be changed. This can be considered to somewhat similar to a person setting up a photocopier, and selecting the number of copies, paper size, color, lightness/darkness and so forth. Until this person actually activates the machine to do the printing, he may hit the reset button and re-enter his input selections over again if they wish. This is no different with respect to the present invention. A player may at any time reset the slot machine or make further changes to how he has set up the machine to run. In this example, although the player's credit meter is now reading 60 credits, he may hit the “Cash Out” button, or the reset button and he actually does have 90 Credits.

Continuing this example above, let us assume the player decides he is happy playing 10 spins at 3 coins per spin and has a machine with numbers that look like this:

| Spins | Credits/Coins Bet | Total Bet | Credits |
|---|---|---|---|
| 10 | 3 | 30 | 60 |

The player would now activate the machine by spinning the reels. This may be done in a number of ways, most likely by actually hitting a button that says “Spin” or pulling the slot machine's arm usually found on the side of the machine, it being understood that as there exists many different slot machines, video poker machines and games, there can be various different ways to actually activate the machine and make such a “spin” occur.

As noted previously, on a traditional slot machine, when a player spins the reels, they are spinning one spin. On that regular slot machine when the player spins, the machine's computer, using what is known as a random number generator, generates a number. This number is then compared with a list of potential outcomes for that machine and the machine brings back, usually through displaying symbols on the reels, what the outcome is. Although it does not have to be a win or a loss, usually this is the case.

If the machine for a regular slot brings back a losing outcome, this will usually be shown in the reel outcome that the player can view. An example for a losing spin could actually be reel one, reel two and reel three stopping on some combination of symbols and blank spaces that when compared to the pay scale of the machine being played is a losing spin. Of course, there is no limit to the number of reels that make up a combination of a losing spin, if there are reels at all. It could bring back a losing spin or play of a game at video poker. Of course, if we look at every casino game found in the world we can determine many different ways a player can lose while gambling.

Of course this spinning process, which generates a randomly generated number, could end with an outcome other than a losing outcome. One of the other possibilities is that the spin could generate something that brings back a winning combination upon the payline. Usually when the player wins, he is paid in the same form he is playing (tokens for tokens and credits for credits) but this is not always the case. Players may win an amount large enough to necessitate them being paid in a variety of other ways, like a cheque, cash or sometimes when players hit grand prizes, they are paid in annuity payments spread over years. Most players who win just have their credit meters incremented by the amount they won on that spin. An example for a regular slot machine might be as simple as a player hits a combination of Bar, Bar and Bar and this combination of symbols pays 25 coins. The players credit meter would be increased by 25 coins in this example.

Understanding how a regular machine works is important to see the value of how MSS machines work. When our player spins the reels, based on the set up we last spoke of as follows:

| Spins | Credits/Coins Bet | Total Bet | Credits |
|---|---|---|---|
| 10 | 3 | 30 | 60 |

Finally, the player is happy with the way he has set up the machine to play out and is ready to play the game. The player spins the reels in any of the many ways casino games may be played. Likely the most common is the pressing of a button on the face of the machine which says “spin”. As is the case with a normal slot machine, the reels would actually spin. Of course unlike a normal slot machine our player has decided to use the very powerful MSS feature that should be found on all slot machines. In our example the player has elected to play 10 spins at one time. MSS is truly a powerful, revolutionary offering for slots and the gaming industry, but ultimately it does not change the game. A player who plays a regular slot machine for one spin at a time and the player who comes later and plays the very same slot machine both have the exact same odds of obtaining the same randomly generated number and the same odds for their money of having some losing, winning and or other combination of outcome, say a bonus being activated. The biggest difference is in the fact the player playing MSS can actually play, if they choose to, at 100 times the speed of a normal player and is not forced to sit through each and every spin if they choose not to.

After the player has hit the spin button, or activated the game in some way, the machine will make all the proper decisions based on the player's desired and selected options. Again, with our example above, the player chose to spin 10 spins at one time for 3 coins per spin. The MSS machine would in our example grab and create 10 randomly generated numbers, or in essence 10 outcomes.

Of course, it is clearly understood that there are numerous ways to determine each outcome and just because a outcome is determined in a way other than by using a random number generator it is understood that MSS will determine in this example 10 different outcomes for the player. Of course, for those skilled in the art it is clearly understood that each spin of a regular slot machine has no memory and is independent of the last or next spin, and each spin at a regular slot machine would generate its own unique randomly generated number, however, it is possible two spins in consecutive order could grab the same randomly generated number. That being said, it is possible for a slot machine to hit the top prize on two straight spins or have a losing combination, even though very rare and highly unlikely, but to any number of consecutive losing spins, for instance to have 100 straight losing spins.

When the MSS machine grabs the 10 totally independent and either the same or different randomly generated numbers and compares these to the list of potential outcomes, one can clearly see and understand that on a MSS played with 10 spins at one time, the player would have the possibility to have any possible number of outcomes. The player could have 10 losses. The player could have 10 wins. The player could have ten bonus games. The player could have any possible combination of the game they are playing. Seeing as MSS is applicable to almost every single game ever invented in the history of slot machines, past, present and in the future, these 10 different spins could be of any combination found within the game the MSS feature is being played on for which the player had spun the reels.

Internally the 10 randomly generated numbers are now generated. In this example lets say they are:
Spin #1) 45,665,789
Spin #2) 12,343,979
Spin #3) 24,333,111
Spin #4) 24,379,800
Spin #5) 34,565,125
Spin #6) 11,343,650
Spin #7) 3,999,459
Spin #8) 24,244,252
Spin #9) 40,497,102
Spin #10) 17,000,001

Of course, this is only one of the ways the outcomes could be determined. For instance each spin may have had one RNG generated for each reel. In our one example, these 10 randomly generated numbers, or eventual outcomes, could be obtained in milliseconds from the time the player activated the spinning of the reels. If the player had spun 50 spins at one time, 50 randomly generated numbers, or outcomes, would have been generated.

Now as fast as each of these numbers was generated, they are compared against a list of possible outcomes for the machine that is being played. From this comparison the machine will determine what outcome is associated with each of these numbers. In our example lets say that each of the numbers were associated with the following outcomes:
Spin #1) 45,665,789 Outcome: Cherry B Bar (SB) B Blank Space
Spin #2) 12,343,979 Outcome: Blank B Bar B Triple Bar (TB)
Spin #3) 24,333,111 Outcome: 5× B Bar—Double Bar (DB)
Spin #4) 24,379,800 Outcome: 5× B 5×—7
Spin #5) 34,565,125 Outcome: Blank B Blank—Blank
Spin #6) 11,343,650 Outcome: Blank B Bar B Double Bar
Spin #7) 3,999,459 Outcome: Bar B Bar—Blank
Spin #8) 24,244,252 Outcome: 5× B Cherry—Blank
Spin #9) 40,497,102 Outcome: Bar B Blank—Bar
Spin #10) 17,000,001 Outcome: Blank B Blank B 5×

Now let's say that the particular machine we were playing had payouts listed as follows:

| | 1^{st} Coin | 2^{nd} coin | 3^{rd} Coin |
|---|---|---|---|
| 5x B 5x B 5x | 1,000 | 2,000 | 10,000 |
| 7 B 7 B7 | 500 | 1,000 | 1,500 |
| T Bar (TB) B TB—TB | 250 | 500 | 750 |
| D Bar (DB) B DB B DB | 100 | 200 | 300 |
| S Bar (SB) B SB B SB | 50 | 100 | 150 |
| Any Bar (AB) B AB B AB | 10 | 20 | 30 |
| Cherry B Cherry B Cherry | 10 | 20 | 30 |
| Any 2 B Cherry | 5 | 10 | 15 |
| Any Cherry | 2 | 4 | 6 |

*5x is Wild and pays 5 Times winning combinations
**5x and 5x pays 25 times winning combination

So in our example, in a second our player spun the reels, playing 10 games at 3 coins. The computer randomly generated numbers that the player will never see, but each number was associated with an outcome, or a potential outcome in the bonus games. Each of the outcomes may or may not be associated with a potential prize and payout to the player.

So comparing the actual spin outcomes to the posted combinations of winning spins on the machine, internally the MSS machine could figure out if how the player actually did on each spin. We know all potential outcomes are based on the game that is being played and in our example we know the top prize is the 5× B 5× B 5×, when playing for 3 coins per spin would pay 10,000 coins.

Each of our spins when compared with the pay schedule had the following payouts:

| | 1^{st} Coin | 2^{nd} coin | 3^{rd} Coin |
|---|---|---|---|
| 5x B 5x B 5x | 1,000 | 2,000 | 10,000 |
| 7 B 7 B7 | 500 | 1,000 | 1,500 |
| T Bar (TB) B TB—TB | 250 | 500 | 750 |
| D Bar (DB) B DB B DB | 100 | 200 | 300 |
| S Bar (SB) B SB B SB | 10 | 20 | 30 |
| Any Bar (AB) B AB B AB | 10 | 20 | 30 |
| Cherry B Cherry B Cherry | 10 | 20 | 30 |
| Any 2 B Cherry | 5 | 10 | 15 |
| Any Cherry | 2 | 4 | 6 |

*5x is Wild and pays 5 Times winning combinations
**5x and 5x pays 25 times winning combination

Spin #1) 45,665,789 Outcome: Cherry B Bar (SB) B Blank Space
   Winning Spin, Pays 6 Credits
Spin #2) 12,343,979 Outcome: Blank B Bar B Triple Bar (TB)
   Losing Spin
Spin #3) 24,333,111 Outcome: 5× B Bar—Double Bar (DB)
   Winning Spin, Pays 150 Credits
Spin #4) 24,379,800 Outcome: 5× B 5× B 7
   Winning Spin, Pays 37,500 Credits
Spin #5) 34,565,125 Outcome: Blank B Blank B Blank
   Losing Spin
Spin #6) 11,343,650 Outcome: Blank B Bar B Double Bar
   Losing Spin
Spin #7) 3,999,459 Outcome: Bar B Bar B Blank
   Losing Spin
Spin #8) 24,244,252 Outcome: 5× B Cherry B Blank
   Winning Spin, Pays 75 Credits (5× is wild, so two cherries and pays 5× that amount)
Spin #9) 40,497,102 Outcome: Bar B Blank B Bar
   Losing Spin
Spin #10) 17,000,001 Outcome: Blank B Blank B 5×
   Losing Spin

Depending on the player's set up input regarding machine action, when the reels do stop, different results may be shown to the player. For instance, if the player had changed the defaults and selected the option to show all winning spins, the reels would have stopped in some order of showing all winning spins. Of course there are many ways to show the winning spins. They may be shown randomly, or from smallest payout to largest payout, or any other way imaginable. If the machine was to only show the player's winning spins, and in the order from the smallest to the largest, the machine would evaluate the winnings spins as follows:
Spin #1) 45,665,789 Outcome: Cherry B Bar (SB) B Blank Space
   Winning Spin, Pays 6 Credits
Spin #3) 24,333,111 Outcome: 5× B Bar—Double Bar (DB)
   Winning Spin, Pays 150 Credits
Spin #4) 24,379,800 Outcome: 5× B 5× B 7
   Winning Spin, Pays 37,500 Credits
Spin #8) 24,244,252 Outcome: 5× B Cherry B Blank
   Winning Spin, Pays 75 Credits (5× is wild, so two cherries and pays 5× that amount)

One can clearly see the machine's computer would recognize that there were four winning spins in the 10 spins the player played. Of these 4 winning spins, they range from a low of 6 credits to a high of 37,500. If that player had chosen to show all the winning spins, the first stop for the reels would be to show the player his winning combination of, in our example, Spin #1 because of the 4 winnings spins, that was the spin that won the player the least amount of money.

Although there is an unlimited number of ways the machine can show the player the winning spins and payouts, there is also an unlimited number of ways the player would be shown and paid each winning combination.

In our current example of the player asking to have the MSS machine stop and show all wins in order of smallest payout to largest the reels would come to rest in order of the first winning spin. Of course we now know this as a combination that paid 6 credits and was as follows:

Spin #1) 45,665,789 Outcome: Cherry B Bar (SB) B Blank Space
Winning Spin, Pays 6 Credits

In our first example Spin #1, reel number one of a three reel machine for use in our example, would have stopped at a Cherry. The second reel would have likely stopped after the first, but this would be totally dependant on the game using the MSS features. In our example the second reel would have stopped and displayed to the player a Single Bar and then if the third reel was to stop last in our example, the final reel in this example would have stopped as a Blank space, which we are referring to a location or stop on the actual reel that contains no symbol at all.

It is possible after showing the player his first win, that the player could have the option to stop the machine, like a pause. This may or may not be allowed, but could be an option afforded the player at this time. What is more likely to occur is the player's credit meter will be incremented by the number of coins or amount won by the player as long as it is not too substantial an amount, in which case the casino would not increment the player's slot machine, but rather have to actually pay the player his winnings using another method.

If in our example the payout for 6 credits to the player was a simple increasing of the credit meter at the time it was stopped on the payline and shown to the player, it is possible the credit meter would immediately be incremented by the six credits and the player's machine would then start to spin again.

The reason for the machine starting to spin again would be to bring back the next winning combination, for the player has asked to see them all. In our example the 10 spins lead to 4 winning spins and the lowest of the 4 was already shown. This next spin of the reels is very unlike a traditional slot machine for there is no random number generated for this spin at this time, it is already known and recorded in the machine's database or computer, waiting to be displayed and paid out to the player. It is also very likely that the player did no action to start the machine spinning for the second time. At this point the player will likely just stand, enjoy the ride and become very excited with the possibility of the next higher-yielding winning spin combination, likely different from and higher than, the previous spins he viewed.

So the machine is spinning at this moment. The machine would grab the next winning spin of the 4 that will all eventually be shown on the slot machine. Of course Spin #1 of our example was already shown from the 4 winning spins:
Spin #1) 45,665,789 Outcome: Cherry B Bar (SB) B Blank Space
   Winning Spin, Pays 6 Credits
Spin #3) 24,333,111 Outcome: 5× B Bar—Double Bar (DB)
   Winning Spin, Pays 150 Credits
Spin #4) 24,379,800 Outcome: 5× B 5× B 7
   Winning Spin, Pays 37,500 Credits
Spin #8) 24,244,252 Outcome: 5× B Cherry B Blank
   Winning Spin, Pays 75 Credits (5× is wild, so two cherries and pays 5× that amount)

So now the machine says, the next lowest winning payout of the 10 spins and 4 wins listed was Spin #8. This spin had an outcome that pays 75 credits to the player. Of course the player still does not know this for the reels have not stopped spinning, to show the 2^{nd} player win. As they do, in our example, reel one would stop on a 5×, reel two on a Cherry and reel three would be a blank space.
Spin #8) 24,244,252 Outcome: 5× B Cherry B Blank
   Winning Spin, Pays 75 Credits (5× is wild, so two cherries and pays 5× that amount)

Now the player can see his next highest winning combination. The player may or may not as of yet know if this is the last spin or if more will follow. The player would be paid 75 credits and this may be added to the player's credit meter at this time. Of course, there is no limit to the number of ways a player can be paid; all at once, or at the end of the last spin, or each time the machine stops between spins, etc.

In our example the player does not know how many wins he has, but he does know he has seen two payouts now, one of 6 credits and the other of 75 for a total of 81 credits. Of course in our example the player only spun the reels, playing in total 10 spins which cost 3 credits per spin for a total of 30 credits.

From our example we can see the next winning combination, in our example of the four wins, now the reels that are spinning are told to get the next highest of the last two payouts left to eventually be displayed:
Spin #1) 45,665,789 Outcome: Cherry B Bar (SB) B Blank Space
   Winning Spin, Pays 6 Credits
Spin #3) 24,333,111 Outcome: 5× B Bar—Double Bar (DB)
   Winning Spin, Pays 150 Credits
Spin #4) 24,379,800 Outcome: 5× B 5× B 7
   Winning Spin, Pays 37,500 Credits
Spin #8) 24,244,252 Outcome: 5× B Cherry B Blank
   Winning Spin, Pays 75 Credits (5× is wild, so two cherries and pays 5× that amount)

We can see that this was Spin #3. Spin number three of the 10 spins was a winning combination that paid 150 credits to the player. Of course the players don't know this but as the reels spin they do know they are winning more. As the reels stop now reel one would stop on the 5×, likely creating quite the roar. Reel two would be the Bar and finally to complete the third winning combination shown to the player, reel three would stop at the Double Bar.
Spin #3) 24,333,111 Outcome: 5× B Bar—Double Bar (DB)
   Winning Spin, Pays 150 Credits

When the machine spins again:
Spin #4) 24,379,800 Outcome: 5× B 5× B 7
   Winning Spin, Pays 37,500 Credits

The final win, not that the players even know that it is the final win yet; comes to stop on the reels as a 5× and 5× and 7. This combination pays 25 times three 7=s which of course in 37,500 credits. The machine likely is not set up to pay out that many credits and the slot attendant will likely be summoned. The example chosen has been made up for effect and not based on an actual slot machine or slot machine payout. It might be unlikely to have a top prize of 10,000 credits and have a payout of 37,500 credits, but the example shows the present invention may be used with any type of game currently offered.

It is very likely the player would be able to view all their spins somewhere on the machine, say in a LED display window. This area would either add the winning spins as they occur, even with a numbering system to show the player that they have more wins, or these may appear in this area only after all winning combinations have been spun. This display would bring back all spins combinations that occurred when the player spun and would list them in all likelihood from the top prize down as shown:

Winning Spins

5× B 5× B 7 Winning Spin, Pays 37,500 Credits
5× B Bar—Double Bar (DB) Winning Spin, Pays 150 Credits
5× B Cherry B Blank Winning Spin, Pays 75 Credits
Cherry B Bar (SB) B Blank Space Winning Spin, Pays 6 Credits
   Losing Spins
Blank B Bar B Triple Bar (TB)
Blank B Blank B Blank
Blank B Bar B Double Bar
Bar B Bar B Blank
Bar B Blank B Bar
Blank B Blank B 5×

This list of all spins that occurred is for the players viewing and shows the player the machine really grabbed 10 outcomes and here they are all in some easy to read format. If the list was long like a 100 spins, the machine window might have a scrolling bar like a computer screen where they player can scroll down. It is also possible that this could just be a player option; “Do you want to see all the spins or not?” It could also be shown in different windows where the winning spins would all show, but the player would have to hit a button or touch screen of sorts to see the other combinations, say the losing combinations of spins. It is very likely the players will only ever view these once and never go back. They might like to see all the winning combinations if they did not choose to have them all spin on the machine. This is done for clarity so they have a better understanding of how come they won what they did.

It is possible that this list of spins could be like a query and the player could alter the way they appear. For instance maybe the player actually wants to view a list of the spins just as they occurred as follows:
Spin #1) 45,665,789 Outcome: Cherry B Bar (SB) B Blank Space
   Winning Spin, Pays 6 Credits
Spin #2) 12,343,979 Outcome: Blank B Bar B Triple Bar (TB)
   Losing Spin
Spin #3) 24,333,111 Outcome: 5× B Bar—Double Bar (DB)
   Winning Spin, Pays 150 Credits
Spin #4) 24,379,800 Outcome: 5× B 5× B 7
   Winning Spin, Pays 37,500 Credits
Spin #5) 34,565,125 Outcome: Blank B Blank B Blank
   Losing Spin
Spin #6) 11,343,650 Outcome: Blank B Bar B Double Bar
   Losing Spin
Spin #7) 3,999,459 Outcome: Bar B Bar B Blank
   Losing Spin
Spin #8) 24,244,252 Outcome: 5× B Cherry B Blank
   Winning Spin, Pays 75 Credits (5× is wild, so two cherries and pays 5× that amount)
Spin #9) 40,497,102 Outcome: Bar B Blank B Bar
   Losing Spin
Spin #10) 17,000,001 Outcome: Blank B Blank B 5×
   Losing Spin

One skilled in the art can determine that there is an unlimited number of ways to display the spins. The preferred embodiment employs the most user friendly, clear and easy way for the players to view this; but there can be dozens of varieties.

However it must be understood that a machine could hit the top prize twice at any time. If the machine does hit two big winning spins there are a number of options that could occur. First off each machine could be programmed that if a winning combination is hit, the remaining spins would not be spun. This would be very simple and the reels would bring back the payouts according to how the player asked to see them returned. The big payout would end up as the final payout on the machine. At this time the player's remaining spins that came after this big payout would be returned to the player for they never occurred. This would be noted to the player by giving the player his credits back and also shown on the screen which normally displays all the players winning and losing spins. This is the “cleanest,” most trouble-free way to take care of players who have hit major jackpots and progressives, prior to the end of their set spins.

Of course this same technology and programming could occur for any player who has a number of smaller wins that have exceeded the amount allowed or room in the credit meter for this particular machine. So if this occurs (where by adding these smaller wins, a number of more credits has been accumulated than the machine can recognize), the machine could use the kick out procedure, stop randomly generating numbers, start the reels stopping process and pay the player accordingly.

There will be an internal process to govern the method by which these credits are added back and how they will work in letting the computer know when to stop creating more randomly generated numbers. Although there are many ways to do this and each machine will be very different, the computer could say we can only have up to 999 credits in this machine at one time. If the unused credits from spins we haven't gotten to, plus any wins that have occurred exceed 999, stop the process. The machine would commence its stopping process and start showing the winning combinations as requested, or in the case of possible jackpots and progressives, those spins first. As the machine builds up, knowing it will stop when the credit meter is full, it could increment the credits unused first back into the players credit meter. Now the machine can pay out the smaller payouts first if this is the case and leave the big payout for the slot attendant. For instance the player wants to spin 100 spins and have a credit meter as such:

| Spins | Credits/Coins Bet | Total Bet | Credits |
|---|---|---|---|
| 100 | 3 | 300 | 600 |

This player's machine's credit meter was almost full and has 900 credits and can only hold 999. The player wants to spin 100 spins. When the reels are activated the 100 randomly generated numbers are started and compared to payouts. As this progressive is happing the machine might say:
Spin #1 (credits 897 B Spin ends with a player loss).
Spin #2 (credits 894 B Spin ends in a player win, 6 Credits for total of 900)
Spin #3 (credits 897 B Spin ends is a player loss)
Spin #4 (credits 894 B Spin ends is a player loss)
Spin #5 (credits 891 B Spin ends is a player loss)
Spin #6 (credits 888 B Spin ends is a player loss)
Spin #7 (credits 885 B Spin ends is a player loss)
Spin #8 (credits 882 B Spin ends is a player loss)
Spin #9 (credits 879 B Spin ends is a player loss)
Spin #10 (credits 876 B Spin ends is a player loss)
Spin #11 (credits 873 B Spin ends is a player loss)
Spin #12 (credits 870 B Spin ends is a player loss)
Spin #13 (credits 867 B ends in a player win, 6 Credits for total of 873)
Spin #14 (credits 870 B ends in a player win, 150 Credits for total of 1020)
   The Machine stops, flagging that the credit meter is now full.

The machine would stop in this example and not grab the final 86 spins for the player, as the credit meter is full on this machine and the machine cannot pay this amount out to this player. If the player had the machine set up to show the top winning combination, the reels would stop at the combination for the spin #14, which pays 150 credits. In essence this example would work no different from a player sitting and spinning one spin at a time and having these same results. For after spin 14, a slot attendant may have needed to have been called depending on the actual machine being played.

The player's credit meter was sitting at 600 after they spun the reels, for if they lost all 100 of the spins, the casino would have kept the players 300 credits, 3 for each of the 100 spins. However what the player does not see is the inner workings of the system. The instant the player spun the reels the machine started grabbing these 100 randomly generated numbers and comparing them to outcomes. When the machine grabbed spin #14, it sent a signal to the operating system that the machine is over the credit limit for this machine and it would stop generating spins. Of course this is only one method that may be used and depending on the actual credit meter on various machines, this number could be any number higher or lower than 999. Of course the machine may just be set up to spin all 100 and worry about how much the player is paid out at the very end.

The reels would now stop on the combination of spin #14 depending on the winning spin return of the players and that of the system. Immediately that player's credit meter might be incremented by the total for the spins that were not actually spun. The player may now need to call an attendant to be paid out. The player may view the list of spins and see what actually occurred and why the machine did what it did. The summary could look like this in our example:

Based on our payouts for our example machine:

| | 1^{st} Coin | 2^{nd} coin | 3^{rd} Coin |
|---|---|---|---|
| 5x B 5x B 5x | 1,000 | 2,000 | 10,000 |
| 7 B 7 B7 | 500 | 1,000 | 1,500 |
| T Bar (TB) B TB — TB | 250 | 500 | 750 |
| D Bar (DB) B DB B DB | 100 | 200 | 300 |
| S Bar (SB) B SB B SB | 10 | 20 | 30 |
| Any Bar (AB) B AB B AB | 10 | 20 | 30 |
| Cherry B Cherry B Cherry | 10 | 20 | 30 |
| Any 2 B Cherry | 5 | 10 | 15 |
| Any Cherry | 2 | 4 | 6 |

*5x is Wild and pays 5 Times winning combinations
**5x and 5x pays 25 times winning combination

Winning Spins
5× B Bar—Double Bar (DB) Winning Spin, Pays 150 Credits
Cherry B Bar (SB) B Blank Space Winning Spin, Pays 6 Credits (×2)
   Losing Spins
Blank B Bar B Triple Bar (TB) (×3)
Blank B Blank B Blank (×3)
Blank B Bar B Double Bar (×2)
Bar B Bar B Blank
Bar B Blank B Bar
Blank B Blank B 5×
   86 un-spun spins
Total Wins 162
Total Loses 42 (14 spins ×3)
Total Unused Spins 86×3=258
   600 Credits+258 Unused 858+12 Wins shown on the payline=870+150 Win=1020.

There are numerous ways to show the above example. Bottom line is the player now has 1020 credits, and if, as in our example the machine cannot pay this amount out, a slot attendant would be summoned.

It is very likely that spin #14 would not have occurred and this player would have actually been able to play the full 100 spins at one time. Of course with newer technology like EZ Pay, machines can pay out much higher number of credits to players, for they are just dispensed on a piece of paper with some recognition code, either a number or a bar code. This player may now use this in another machine or take the ticket to the cashiers cage and receive the required amount of winnings.

With the MSS technology a player could spin 100 spins in seconds. Paying out of the credits won, and depending on how many winning combinations a player brings back; this entire process could easily occur in well under a minute. It is even possible it occurs at the same rate as another player spinning just one spin on a regular slot machine. Even if the process was slowed and the player only spins 100 spins in a minute, it can be shown that this player could get two bonus spins of the wheel per minute and could get 8 to 10 bonus spins in the same amount of time as the player who spins the machines as machines are now spun, one spin at a time.

Although it is understood that spinning the reels at such an increased pace can lead to the casino making more money, or getting all the player's money much faster, this player also had his share of action and did not have to witness a losing spin. In the end, both players could lose their money, and the player who still elects to play the machine at one spin per spin has not had his casino entertainment altered in any way by MSS for he simple did not use the option which is now on every machine including the machine he was using. However, his stay might be longer, but he actually did not receive more spins, they just occurred over the longer period of time. This player did not win or lose more frequently; he just played at a slower pace. What this player did have to do however, was witness all the losing spins it took for the casino to get his money, and they ultimately will and do. So the player who used the MSS technology actually lost the same amount of money, but it is possible they never witnessed more than one losing spin all night, the last spin before their credit meter turned to zero and their play session came to an end.

Progressive slot machines are very attractive for slot machine players for they have a chance, on a single spin, to win millions of dollars. Companies like IGT have really effected this market with a patent on Wide Area Progressives, linking machines at different locations to the same jackpot. The allowed for casinos to now participate in large jackpots that they would otherwise have never been able to be a part of. The reason for this was very simple, they did not have the play within their own casino to grow a jackpot well into the millions.

Slot machine jackpots take a little bit per spin and add this to the top prize. A machine like Megabucks™, an IGT product, and known as the biggest progressive jackpot in the world for slot machines, adds like pennies per spin of the reels. If we assume that they added $0.06 per $3 spin, with the high odds of winning the top prize, people lose, and eventually a huge pot is grown. Because jackpots are built by players losing, the more players that contribute to the jackpot the faster and larger it can grow. Working backwards, this is saying, the more players who lose money to Megabucks™, the more money the actual winners end up with when the top prize is won.

Logic tells us that the more the machines are spun, the higher the pot could grow, as well as the faster it could grow. If Megabucks™ had 3,000 machines contributing to one jackpot, the most players it could have spin would be 3,000. If these machines were full and spun for 12 spins each per minute and $0.06 per spin was added to the progressive, the most they could add to the progressive jackpot per minute is:
3,000×12×$0.06=$2,160×24 hours/day=$51,840

In one 24 hour period this machine under this example would only grow the top prize by $51,180.

Consider MSS, had these same 3,000 machines and there is no limit as to how fast these pots now could grow. If the average player played for 3 spins per spin, this daily pot would grow at three times the rate, or about $155,520. Not only that; but the manufacturer of these machines are making more money for they too profit off the amount of action these machines get. The casino wins, for they profit from the action the machines get. Machines like progressives actually stand to gain the most by the MSS technology for it is commonly known that most people only play these machines for their chance to win big and so the actual excitement level is a non factor for playing.

With machines like Megabucks™, as the jackpot really grows into the 20 and 30 millions of dollars, play definitely increases. The MSS technology at this time will make it quicker for players to play their $20 in the machine and move on. This can free up the busy machines as the progressive grows. Many players will walk up to a Megabuck™ machine and put in $50. They will play maximum coins and maximum spins, so in this case 12 spins at one time and win or lose that fast, almost on impulse. The player will lose and walk away just that quick and be just as satisfied if not more satisfied than the player who spun one spin at a time and had to sit through every loss. The reason is they did not waste any time doing what they set out to do, win the jackpot or lose their money.

Industry numbers are saying players lose, on average, about 75% of what they put into the machines. A player might say, wow, what a rip off. A casino might say, wow, the player still has 75% of what they walked in the door with when they leave.

It is also a fact that MSS can increase the casino entertainment value for the player, by having the odds of the machine, the pay back to the players, higher. It is simple math that MSS machines can make the casino more money, by offering the player a much better pay back.

### EXAMPLE

Spins Per Hour
$0.75 times 12 (one spin every 5 seconds)=$9.00@15% hold=$1.35 for Casino
$0.75 times 12 times 10 per (10 spins at once)=$90@5% hold=$4.50 for Casino
$0.75 times 12 times 10 per (10 spins at once)=$90@2% hold=$1.80 for Casino

In most gaming jurisdictions, the law only requires the casino to give about 75% back to the players. Of course this is a minimum and it is up to the casinos, so they will pay out higher on certain machines to attract play and not lose customers to their competition. In our first example above, we used an 85% payback percentage to the player. In other words, over the long haul the casino will keep 15%. You can see how in just a few spins the casino profit can really add up. With MSS, casinos could now set the machines to a much higher payback to the player, levels than ever seen before, which in turn gives the most possible back to the player.

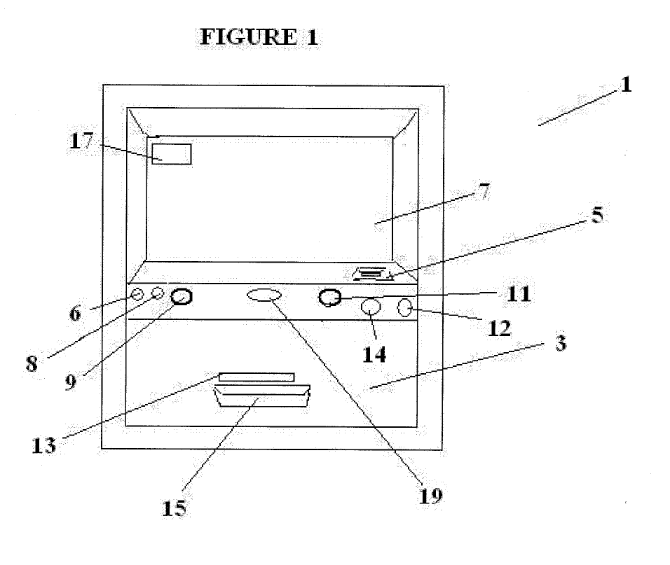

Referring to FIG. 1, there is illustrated an example of a slot machine 1 which could be utilized in accordance with the present invention. A front panel 3 on the slot machine 1 can be opened or closed through, for example, a hinge (not shown), the front panel 3 being provided for the purpose of accessing the interior of the slot machine 1, when, for example, an adjustment of the parts housed therein, a check for a counter which counts the number of coins inserted, or a collection or replenishment of coins, is required. The interior of the slot machine will, of course, house a plurality of reels (not shown) therein, each having game symbols located thereon.

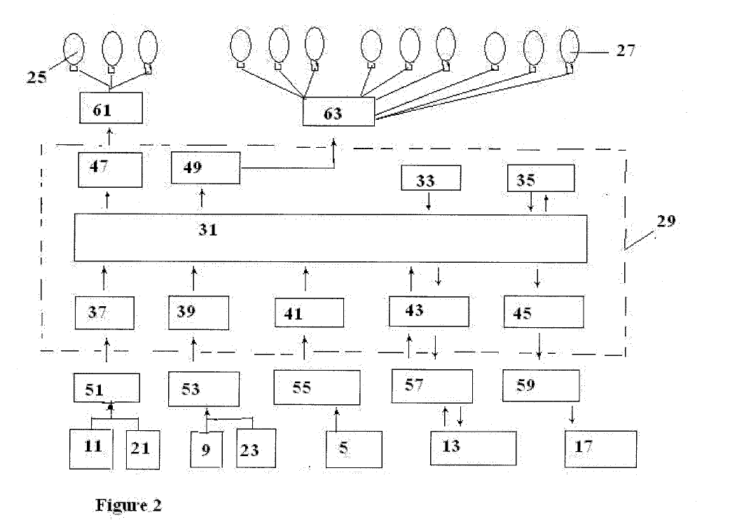

The front panel 3 is provided with display window 7, which is sufficiently large in size for viewing the symbols depicted on an outer periphery of each reel through respective windows. Furthermore, there is provided on the slot machine 1 a coin insertion slot 5, a “default play” start lever or button 11 (used for activation of the reels housed within the slot machine), multiple spin lever or button 9 (used by the player, when desired, as hereinafter described), a coin ejection outlet 13, and a saucer 15. A credit meter 17 on display window 7 may also display the number of coins to be ejected, when a prize-winning symbol combination on the reels is attained. Alternatively, the number shown on the credit meter 17 is decreased every time a coin is ejected through the coin ejection outlet 13 into the saucer 15. In accordance with the present invention, the presence of multiple spin lever or button 9 provides a player game play options as follows. First, the player is afforded the “default” option of effecting a singular spin of the reels, through selection of start lever or button 11 ( and through which generates one randomly generated number (in essence one final outcome, one play=one spin at a time), or of effecting multiple spins on a slot machine, through selection of multiple spin lever or button 9 so as to generate multiple randomly generated numbers which can all be compared with a list of potential outcomes to determine if the player will win or lose and by doing so creating many different outcomes at one time (in essence, one play=multiple spins generated at one time). The “default play” start lever or button 11 is further associated with “Bet” button 12 and “payout” button 14, through switch section 21, as shown in FIG. 2, and as hereinafter described. The multiple spin lever or button 9 is further associated with “Bet” button 6 and “payout” button 8, through switch section 23, as shown in FIG. 2, and as hereinafter described.

It should be noted that the multiple spin lever or button 9 is a player option. In a preferred embodiment, if a player wanted to switch from playing the multi-spin option, they would merely select the “default play” start lever or button 11 for subsequent spins. Likewise, if they wanted to switch from playing the “default play” to multi-spin, they would similarly select the multiple spin lever or button 9. In a preferred embodiment, the player selecting the multiple spin lever or button 9 option can select how many multiple spins they wish to be generated at one time, such as, for example, 2, 5, 10, 25, 100 or even more spins. In this embodiment, the player may press the multiple spin lever or button 9 numerous times until the desired number of multiple spins appears on the display window to be selected by the player, with each tap of the button being equal to a preset amount to incrementally increase or decrease the spins. Alternatively, the player may hold the multiple spin lever or button 9 down until the desired number of multiple spins appears on the display window to be selected by the player, the desired number being selected, of course, when the player releases the multiple spin lever or button 9. Of course, other variations are also conceivable, as would be readily apparent to one skilled in the art. For example, one way the player will instruct the machine could be a simple toggle switch, similar to a volume control button found on many car stereos. This toggle could come in many different forms (rotary knob, dial, button, switch, touch screen, keypads, or any other method commonly used to increase or decrease). One way, as noted above, is to allow the player to press and even hold a button to increase or decrease the desired number of multiple spins until they arrive at one they wish to select. For instance, if the player wanted to play 10 spins per spin, they might toggle a button that says “+” plus spins and “−” minus spins, up or down, depending on what the spin amount was previously set at.

The same methods used to change the desired number of spins could also be used to change or vary how many credits the player wishes to bet on each of those spins. Although it is possible to allow the player to bet a different number on certain spins, in the preferred embodiment the player would bet the same amount on each and every multi spin. This inputting and selection of the number of units to bet on this next spin, or each spin, may, of course, have to conform to the actual casino betting limit for that machine, as well as different denominations. It is also conceivable that the slot machine could provide to the player a means to display only the “winning” spins that were derived from the plurality of spins selected and that, further, these “winning spins” be displayed in a ranking order, from highest to lowest payouts, or vice versa.

So, if the slot machine requires the player to play between one and three credits/coins/tokens or units per spin, then the player would, of course, have to conform to these limits. It is possible that a player could play just one credit per spin and spin the machine any amount of times. All wins for these spins would be on the payout based on spinning the reels at one credit. If the player spun each spin for 3 credits, then the payouts for any wins would be based on the payouts as such. It is also known for conventional slot machines that certain machines may require the player to play maximum coins per spin if they wish to qualify and win any progressive jackpots associated with that machine. With respect to the present invention, this is no different, in that if players are playing at a progressive machine configured to utilize the present invention, the payout's don't change, nor do the rules of qualifying for certain bonus or progressive jackpots.

Of course, the player may use the buttons, found on the slot machine face, for selecting the number of credits to bet per spin, or may be prompted in a number of other ways, which would be readily apparent to one skilled in the art. After the player has input the number of spins to play, the player will input the amount of credits to bet per spin. This may be another toggle switch, or even the same toggle switch (or any other method) as the player previously used to increase or decrease the number of spins, or any other conventional means.

In a further embodiment, if, for example, the previous player of the slot machine was playing the multi-spin option the machine would reset itself, for example, after a certain period of time had elapsed on an idle machine (or money is added, or the machine is cashed out) to the “default play” mode (one play=one spin) under the preferred embodiment. In effect, in this embodiment, the machine will always default to the “default play” mode and players must manually select the multi-spin option, to ensure it cannot happen accidentally. In a still further embodiment, the slot machine of the present invention may also have a reset button on the machine, which the player can quickly use to reset the machine to the “default play” mode.

Of course, after insertion of a coin or coins through coin insertion slot 5, the reels begin to rotate simultaneously with the pulling of the start lever or button 11 (or if the player has chosen the option of using multiple spin lever or button 9). While it is to be understood that, in the preferred embodiment, players can wager units such as currency and coins through coin insertion slot 5, it is also to be understood that tokens, identification cards, player tracking cards, ticket in/ticket out acceptance, and the like could also be utilized. While not illustrated, it is also well known to provide a cash reader to accept cash denomination wagers, the cash reader enabling the player to accumulate credits for wagering with the slot machine 1. Additionally, means may be provided for the player to wager from funds on a debit card, credit card or the like as is known in the art.

Firstly, how to play the slot machine according to this embodiment will be explained. It should be noted that the slot machine according to this embodiment is one of the mechanical reel type that, preferably, comprises three reels (referred to generally as “25” in FIG. 2), these reels being used in conjunction with the “default play” start lever or button 11 through switch section 21. The machine will also utilize, if the player selects the multiple spin lever or button 9, a plurality of reels (referred to generally as “27” in FIG. 2), for playing the multi-spin slots option as hereinafter described. Of course, it will be understood that other slot machine variations could also be utilized.

A player firstly inserts a certain number of coins into coin insertion slot 5 of the slot machine 1. Next, the player selects either the “default play” start lever or button 11 in a switch section 21, or selects the multiple spin lever or button 9 in a switch section 23. If the player has selected “default play” start lever or button 11, the three reels 25 begin to rotate simultaneously, while if the player has selected the multiple spin lever or button 9, reels 27 begin to rotate simultaneously, it being understood that the plurality of reels are each arranged in groups of three, in the preferred embodiment, so as to form multiple groupings of reels from which the multi-spin play option can be effected. Of course, each reel will have a plurality of symbols drawn on the peripheral surface of each reel, as is well understood in the art. The series of the symbols on the reels are seen to move through their associated display window, as is also well understood in the art. When a certain period of time passes, the reels stop one after another. At this time, if three symbols of any one set of grouped reels are aligned along a winning line, and agree with a preset winning combination of the symbols, a number of coins or other currency corresponding to the winning combination of the symbols is paid at coin ejection outlet 13, and into saucer 15. The number of the paid coins is displayed at a certain position in credit meter 17. If the combination of the symbols aligned along the winning line does not agree with a preset winning combination of the symbols, no coins or other currency are paid. Thus, one game is completed.

If the player has selected the “default play” start lever or button 11, when a game is played after Bet button 12 in the switch section 21 is pushed, and the number of the coins remaining after the bet or wager is placed is displayed at “Credit” in credit meter 17, and is equivalent to the number of coins remaining. Of course, when the Bet button 12 in the switch section 21 is pushed once, 1 is added to the number displayed at “Coin” in the credit meter 17, while 1 is subtracted from the number displayed at “Credit”. Likewise, if the player has selected the multiple spin lever or button 9 option, when a game is played after Bet button 6 in the switch section 23 is pushed, the number of the coins remaining after the bet or wager is placed is displayed at “Credit” in credit meter 17, and is equivalent to the number of coins remaining. Of course, when the Bet button 6 in the switch section 23 is pushed once, 1 is added to the number displayed at “Coin” in the credit meter 17, while 1 is subtracted from the number displayed at “Credit”.

Of course, regardless of if the player has selected “default play” start lever or button 11 or multiple spin lever or button 9, when their respective pay out buttons 14, 8 are pushed, the same number of coins as that displayed at “Credit” in the credit meter 17 are paid out at coin ejection outlet 13, and into saucer 15.

With reference to FIG. 2, one embodiment of a slot machine through which this embodiment of this present invention could be utilized is played in the above described mode. A microcomputer 29 generally controls the slot machine. The microcomputer 29 is operated mainly by a central processing unit (CPU) 31 and comprises a read only memory (ROM) 33, a random access memory (RAM) 35, and interfaces 37, 39, 41, 43, 45, 47 for connections with external circuits. ROM 33 stores main programs, and various other programs, as would be well understood in the art. RAM 35 is a memory which timely writes and reads necessary data during operations, and its functions are also well understood in the art and will not be elaborated further.

The interface 37 is for introducing the signal from a switch detecting circuit 51 to CPU 31, when, of course, the player has selected the “default play” start lever or button 11. The switch detecting circuit 51 detects the operational state of start lever or button 11, and the “Bet” button 12 and “payout” button 14 in switch section 21.

The interface 39 is for introducing the signal from a multi-spin switch detecting circuit 53 to CPU 31, when, of course, the player has selected the multiple spin lever or button 9. The multi-spin switch detecting circuit 53 detects the operational state of multiple spin lever or button 9, and the “Bet” button 6 and “payout” button 8 in switch section 23.

The interface 41 is for introducing the signal from a coin detecting circuit 55 to CPU 31. The coin detecting circuit 55 counts the number of coins inserted into coin insertion slot 5. The interface 43 is for supplying the signal from CPU 31 to coin pay out means 57 and introducing the signal from the coin pay out means 57 to CPU 31. The coin pay out means 57 drives a coin pay out hopper in response to a command of CPU 31 and pays out a number of coins required by the command onto, with reference agin to FIG. 1, saucer 15 through coin ejection outlet 13. Further, the coin pay out means 57 informs CPU 31 through the interface 43 of a lack of stored coins and a failure of the coin pay out means 57 per se. The interface 45 is for supplying the signal from CPU 31 to a display circuit 59. The display circuit 59 controls the respective displays in the credit meter 17.

The interface 47 is for supplying the signal from CPU 31 to a reel drive control circuit 61, when, of course, the player has selected the “default play” start lever or button 11. The reel drive control circuit 61 controls the stop and the drive of stepping motors (not shown, but which are well known in the art) which drive the reels 25 and can stop any of the respective reels 25 at required stop positions using the detected outputs from, for example, conventional photosensors (not shown, but which are well known in the art) which could, also for example, detect positioning projections (not shown) provided on the respective reels 25. In this manner, and as a worker skilled in the art would understand, the stop position of each of the reels in 25 can be controlled by controlling the number of drive steps after a detection of the positioning projection. The interface 49 is for supplying the signal from CPU 31 to a further multi-spin reel drive control circuit 63, when, of course, the player has selected the multiple spin lever or button 9. The reel drive control circuit 63 controls the stop and the drive of stepping motors (not shown, but which are well known in the art) which drive the plurality of reels 27 and can stop any of the respective reels 27 at required stop positions, as noted above.

Next, the operation of the slot machine according to this embodiment will be explained. In the slot machine according to this embodiment, the symbols on the reels are chosen based on a random number. To this end CPU 31 has a function of generating random numbers. A characteristic of the slot machine of the present invention is that, if the player has selected the “default play” start lever or button 11, a single random number is generated, which can be compared with a list of potential outcomes to determine if the player will win or lose. Alternatively, if the player has selected the “multi-spin” option through selection of multiple spin lever or button 9, multiple random numbers are generated which can all be compared with a list of potential outcomes to determine if the player will win or lose, it being understood that each of the random numbers are utilized and generated for a corresponding grouping of reels in the plurality of reels 27 in FIG. 2. In the preferred embodiment, individual reels are grouped together in 3's, so one random number is generated for each grouping of three reels, and so forth. Again, the generation of a random number described above, or multiple random numbers, as well as the control of any of the reels and the credit meter 17 are executed by CPU 31, in a manner which would be simply understood by a worker skilled in the art.

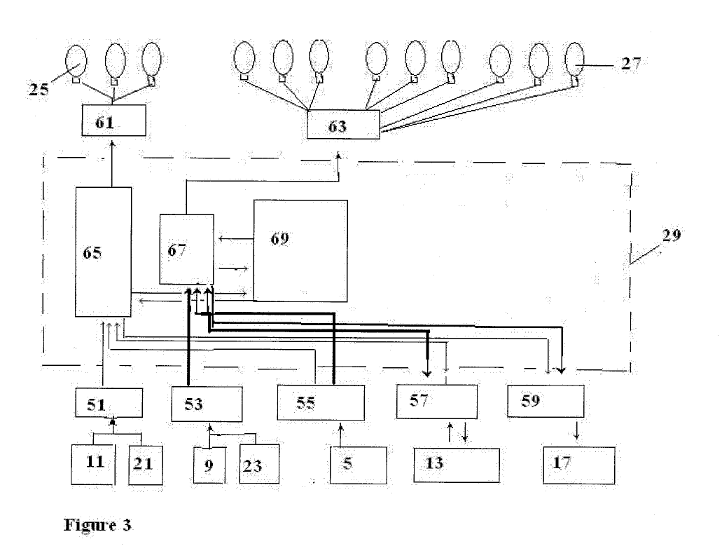

FIG. 3 is a block diagram showing the function of the microcomputer 29 which makes the above described operation. The microcomputer 29 further comprises drive control means 65, multi-spin drive control means 67 and random number generating means 69. When the player has selected the “default play” start lever or button 11, through link to switch detecting circuit 51, the microcomputer 29 enables the drive control means 65 to control the coin pay out means 57 and the reel drive control circuit 61, based on the information supplied by the switch detecting circuit 51, coin detecting circuit 55 and the random number generating means 69.

Alternatively, when the player has selected the multiple spin lever or button 9 option, through link to multi-spin switch detecting circuit 53, the microcomputer 29 enables the multi-spin drive control means 67 to control the coin pay out means 57 and the multi-spin reel drive control circuit 63, based on the information supplied by the multi-spin switch detecting circuit 53, coin detecting circuit 55 and the random number generating means 69.

The random number generating means 69 generates a reference random number (or multiple random numbers), which are supplied to the drive control means 65 (if the player has selected the “default play” start lever or button 11), or, the random number generating means 69 generates multiple reference random numbers which are supplied to the multi-spin drive control means 67 (if the player has selected the multiple spin lever or button 9). When the required conditions for starting a game are met, and if the player has selected the “default play” start lever or button 11, the drive control means 65 energizes the reel drive control circuit 61 to rotate the reels and, eventually, stop the reels so that the combination of the symbols of the set of three grouped reels 25 are presented and aligned along a pay line, and, if this payline combination so presented agrees with a preset winning combination of the symbols, then the drive control means 65 commands the coin pay out means 57 to pay a number of coins or other currency corresponding to the combination of the symbols, this being paid at coin ejection outlet 13, and into saucer 15. By the same token, when the required conditions for starting a game are met, and if the player has selected the multiple spin lever or button 9 option, the drive control means 67 energizes the multi-spin reel drive control circuit 63 to rotate the reels and, eventually, stop the reels so that the combination of the symbols on any of the sets of reels contained in the plurality of grouped reels 27 are presented and aligned along a pay line, and, if payline combinations for any of the sets of reels contained in the plurality of grouped reels 27 so presented agrees with a preset winning combination of the symbols, then the drive control means 67 commands the coin pay out means 57 to pay a number of coins or other currency corresponding to the combination of the symbols, this being paid at coin ejection outlet 13, and into saucer 15.

In one embodiment of the present invention, and as noted above, the default play” start lever or button 11 and the multiple spin lever or button 9 utilize separate switch detecting circuit 51 and multi-spin switch detecting circuit 53, respectively, to supply the signal from CPU 31 to reel drive control circuit 61, (when the player has selected the “default play” start lever or button 11) or multi-spin reel drive control circuit 63, (when the player has selected the multiple spin lever or button 9). It will be readily understood by persons skilled in the art that a singular switch circuit could be utilized, instead, rather than two separate switch circuits, so as to direct the intention of player from a “default” single spin=single play option, to a single spin=multi-play opportunities, as is provided in the present invention.

The present invention has been described herein with regard to preferred embodiments. However, it will be obvious to persons skilled in the art that a number of variations and modifications can be made without departing from the scope of the invention as described herein.

1. A slot machine comprising:
a singular spin play command, which can be activated by the user to generate a single random number;
a multiple spin play command which can optionally be activated by the user for generating multiple random numbers;
at least one display reel having a plurality of game symbols thereon,
a plurality of display reels with each reel having a plurality of game symbols arranged thereon;
display means for displaying the game symbols;
reel drive means responsive to the singular spin play command, when the singular spin
play command has been selected by the user, for rotatably driving and stopping the at least one display reel;
multiple spin reel drive means responsive to the multiple spin play command, when the multiple spin play command has been selected by the user, for rotatably driving and stopping the plurality of display reels;
random number generator means for generating the single random number, in response to the activation of the singular spin play command by the user, or generating the multiple random numbers, in response to the activation of the multiple spin play command by the user, from a predetermined set of random numbers; and
processing means for comparing the single random number or multiple random numbers to a predetermined set of potential game results so as to establish a game result.

2. The slot machine of claim 1, wherein the at least one display reel is rotatably mounted to selectively display the game symbols.

3. The slot machine of claim 1, wherein each of the plurality of display reels are rotatably mounted to selectively display the game symbols.

4. The slot machine of claim 1, wherein the means for displaying the game symbols further comprises a video screen having a plurality of display zones thereon, for displaying the game symbols associated with each of the at least one display reel and the plurality of display reels.

5. The slot machine of claim 1, wherein the slot machine further comprises:
an input sensor for sensing tokens delivered to the slot machine; and
a processor operatively connected to the input sensor for receiving information about the tokens entered into the slot machine and for initiating a cycle of the slot machine.

6. The slot machine of claim 1, wherein the reel drive means further comprises stopping the at least one display reel such that at least one symbol on the at least one display reel is displayed to the user across at least one payline.

7. The slot machine of claim 1, wherein the multiple spin reel drive means further comprises stopping the plurality of display reels such that at least one symbol on each of the plurality of display reels is displayed to the user across at least one payline.

8. A slot machine comprising:
an input sensor for sensing tokens delivered to the slot machine;
a processor operatively connected to the input sensor for receiving information about the tokens entered into the slot machine and for initiating a cycle of the slot machine;
a singular spin play command, which can be activated by the user to generate a single random number;
a multiple spin play command which can optionally be activated by the user for generating multiple random numbers;
at least one display reel having a plurality of game symbols thereon,
a plurality of display reels with each reel having a plurality of game symbols arranged thereon;
display means for displaying the game symbols;
reel drive means responsive to the singular spin play command, when the singular spin play command has been selected by the user, for rotatably driving and stopping the at least one display reel;
multiple spin reel drive means responsive to the multiple spin play command, when the multiple spin play command has been selected by the user, for rotatably driving and stopping the plurality of display reels;
random number generator means for generating the single random number, in response to the activation of the singular spin play command by the user, or generating the multiple random numbers, in response to the activation of the multiple spin play command by the user, from a predetermined set of random numbers; and
wherein the processor compares the single random number or multiple random numbers to a predetermined set of potential game results so as to establish a game result.

9. The slot machine of claim 8, wherein the game result is displayed to the user by the display means.

10. The slot machine of claim 8, wherein the reel drive means further comprises stopping the at least one display reel such that at least one symbol on the at least one display reel is displayed to the user across at least one payline.

11. The slot machine of claim 8, wherein the multiple spin reel drive means further comprises stopping the plurality of display reels such that at least one symbol on each of the plurality of display reels is displayed to the user across at least one payline.

12. The slot machine of claim 1, wherein the multiple spin play command can be depressed and held until a desired number of multiple spins is reached, at which point the user will discontinue contact with the multiple spin play command so as to select the desired number of multiple spins.

13. The slot machine of claim 1, wherein the multiple spin play command can be repeatedly tapped until a desired number of multiple spins is reached, at which point the user will discontinue contact with the multiple spin play command so as to select the desired number of multiple spins.

14. The slot machine of claim 1, wherein a variable number of the multiple random numbers can be generated by the user for each spin of the slot machine.

15. The slot machine of of claim 9, wherein a display control circuit is operably interconnected between the processor and the display means, so as to facilitate display of the game result to the user.

16. The slot machine of of claim 5, wherein a coin pay out means is operably interconnected between the processing means and the input sensor.

17. The slot machine of of claim 16, wherein, when the game result presented from the processing means is a winning game result for the user, the coin pay out means provides a number of currency to the user.

18. A slot machine comprising:
play means which can be activated by the user to generate a single random number for a single spin, or which can optionally be activated by the user to generate multiple random numbers, each of which is associated;
a plurality of display reels with each of the reels having a plurality of game symbols arranged thereon;
display means for displaying the game symbols;
reel drive means responsive to the play means for rotatably driving and stopping the plurality of display reels;
random number generator means for generating the single random number or generating the multiple random numbers, in response to the activation of the play means by the user, from a predetermined set of random numbers; and
wherein the processor compares the single random number or multiple random numbers to a predetermined set of potential game results so as to establish a game result, the game result being displayed to the user by the display means.

19. The slot machine of claim 18, further comprising input means for sensing tokens delivered to the slot machine.

20. The slot machine of claim 19, further comprising processing means operatively connected to the input sensor for receiving information about the tokens entered into the slot machine and for initiating a cycle of the slot machine.
